(19) United States
(12) Patent Application Publication
(10) Pub. No.: US 2021/0085566 A1
(43) Pub. Date: Mar. 25, 2021

(54) FORMULA AND POWDER MIXING ASSEMBLY

(71) Applicant: Ann KEENAN, Miami, FL (US)

(72) Inventor: Ann KEENAN, Miami, FL (US)

(21) Appl. No.: 17/019,257

(22) Filed: Sep. 12, 2020

Related U.S. Application Data
(60) Provisional application No. 62/902,481, filed on Sep. 19, 2019.
(60) Provisional application No. 62/946,492, filed on Dec. 11, 2019.

(51) Int. Cl. A61J 9/00; B01F 1/00; B01F 15/00; B01F 15/02; A61J 11/04; A61J 11/00

(52) U.S. Cl. CPC A61J 9/00; B01F 1/0016; B01F 15/00974; B01F 2215/0014; A61J 11/04; A61J 11/008; B01F 2001/0088; B01F 15/0225

(57) ABSTRACT

Described herein is a baby bottle formula mixing and feeding assembly designed to be coupled to a standard baby feeding bottle or powder mixing bottle. The formula mixing assembly is designed to include at least four main components: a bottom housing, a cylindrical gate body, a top housing and a cylindrical pliable cup body disposed within the top/bottom housing. A locking mechanism is included that unlocks the top housing and the gate body containing the pliable cup body and the formula, such that the apertures in the gate body align with the apertures in the bottom housing to when the top housing is rotated so as to empty the formula contents into the bottle with the liquid. e both the bottom housing and the gate body.

### CLAIM OF PRIORITY

This application claims priority to and the benefit of US Provisional Applications with Ser. No. 62/902,481 and filed on Sep. 19, 2019, and with Ser. No. 62/946,492 and filed on Dec. 11, 2019, respectively, both entitled ON THE GO FORMULA DISPENSER, both of which are hereby incorporated in their entireties.

### FIELD OF THE INVENTION

The inventive concept relates generally to a baby formula or powder mixing feeding assemblies.

### BACKGROUND

Currently powder baby formula is typically measured in a proper ratio, depending on the baby or infant's age, to the amount of water in the bottle and then immediately added to the water and mixed just minutes prior to feeding and consumption. This traditional approach is typical for at home preparation and feedings, but it does impose an inconvenience to the parents or caregivers while traveling or in public places. Since infants require frequent feeding and since liquid formula bottles or milk require refrigeration to prevent spoilage, portability is a challenge and the heating of same required prior to consumption also presents a challenge to the parent or caregiver. While the refrigeration and heating can be avoided by blending a powder and water just prior to consumption, this poses an inconvenience and potentially messy situation while traveling and requires substantial preparation prior to leaving home with the infant.

One solution is using premixed baby formulas that can be placed into the feeding bottle just prior to feeding, however this is a very expensive solution due to the number of times an infant needs to be fed. This also does not consider the disposal of the leftover bottles of the premixed formula. Even in this case, heating of the liquid formula prior to feeding is still a challenge. Some current solutions require an investment in an entire new feeding assembly as these do not work well with standard baby bottle cap and nipple assemblies. Therefore, there currently exists a need in the market for device or apparatus that simplifies the portability and preparation of baby formula feeding bottles while away from home.

### SUMMARY OF THE INVENTION

The inventive concept relates, in general, to baby feeding bottles using premixed or powder formula and, more particularly, this inventive concept relates to an improved method for transporting and conveniently mixing dry formula and water in the proper ratio to prepare a ready-to-feed bottle in travel or non-home situations. The inventive concept is applicable to other applications such as sports drinks, energy drinks and other beverages that can be mixed in the field.

In one example embodiment, there is provided baby bottle formula mixing and feeding assembly including a cylindrical vessel having a body portion with an opening portion, the opening portion having a circular sidewall protruding up from the body portion with a vessel rim. The baby bottle formula mixing and feeding assembly also include a standard nipple and cap ring assembly as well. There is also included a baby formula mixing assembly adapted to be coupled with the opening portion of the cylindrical vessel, with the baby formula mixing assembly include at least four main components: a bottom housing, a cylindrical gate body, a top housing and a cylindrical pliable cup body disposed within the top/bottom housing. Specifically, the formula mixing assembly includes a bottom housing member having a concave opening with a bottom housing member rim and a floor plate with a first set of apertures, the concave opening defined by an inner sidewall that mates with the floor plate, the bottom housing member including an outer sidewall adjacent the inner sidewall collectively defining a cavity therebetween designed to receive the vessel rim. The cylindrical gate body is designed to be disposed within the concave opening of the bottom housing member and have a gate body rim and a bottom plate with a second set of apertures, the bottom plate further including a center post that protrudes outwardly and is designed to contact the floor plate to facilitate radial rotational movement of the gate body within the bottom housing member, the gate body rim having at least one stopper tab protruding laterally from the gate body rim. Further, the top housing member is designed to mate with the bottom housing member and encase the gate body, the top housing member having an upper opening threaded rim and a lower opening designed to rotatably engage with a lip arrangement on the rim of the bottom housing member, the top housing member further designed to radially rotate the gate body to align the second set of apertures of the gate body with the first set of apertures of the bottom housing member. Furthermore, the mixing assembly includes a cylindrical pliable cup body designed to be located within the top and bottom housing and partially inside the gate body, the cup body having an outer ring on an exterior surface designed to be in contact with at least one release button protruding through the top member housing and in contact with the at least one stopper tab of the gate body, wherein the outer ring, the at least one stopper tab and the one release button member form a locking mechanism for the formula mixing assembly to prevent rotation of the top housing member and the gate body. Finally, the nipple and cap ring assembly mates with the baby formula mixing assembly with the cap ring having a threaded surface designed to be threaded onto the top housing member rim. Unlike the prior art, axial rotation and longitudinal movement to align the apertures is not required in this embodiment to promote flow through of powder and fluid.

In another example embodiment, there is provided a baby bottle formula mixing and feeding assembly designed to be coupled with an opening portion of a mixing vessel, the formula mixing assembly including a bottom housing member having a concave opening with a bottom housing member rim and a floor plate with a first set of apertures, the concave opening defined by an inner sidewall that mates with the floor plate, the bottom housing member including an outer sidewall adjacent the inner sidewall collectively defining a cavity therebetween designed to receive a rim of the mixing vessel. The assembly further includes a cylindrical gate body designed to be disposed within the concave opening of the bottom housing member and having a gate body rim and a bottom plate with a second set of apertures, the bottom plate further including a center post that protrudes outwardly and is designed to contact the floor plate to facilitate rotational movement of the gate body within the bottom housing member, the gate body rim having at least one stopper tab protruding laterally from the gate body rim. In addition, a top housing member designed to mate with the bottom housing member and encase the gate body, the top housing member having an upper opening threaded rim and a lower opening designed to rotatably engage with a lip arrangement on the bottom housing member rim, the top housing member further designed to rotate the gate body to align the second set of apertures of the gate body with the first set of apertures of the bottom housing member. Further, the assembly includes a cylindrical pliable cup body designed to be located within the top and bottom housing and partially inside the gate body, the cup body having an outer ring on an exterior surface designed to be in contact with at least one release button protruding through the top member housing and in contact with the at least one stopper tab of the gate body, wherein the outer ring, the at least one stopper tab and the one release button member form a locking mechanism for the formula mixing assembly to prevent rotation of the top housing member and the gate body.

In yet another example embodiment, there is provided a powder mixing assembly designed to be coupled to an opening portion of a mixing vessel (such as a water or juice bottle used for fitness scenarios and athletic clubs) partially filled with a liquid, with the powder mixing assembly including a bottom housing member having a concave opening with a bottom housing member rim and a floor plate with a first set of apertures, the concave opening defined by an inner sidewall that mates with the floor plate, the bottom housing member including an outer sidewall adjacent the inner sidewall collectively defining a cavity therebetween designed to receive a rim of the mixing vessel. The assembly also includes a cylindrical gate body designed to be disposed within the concave opening of the bottom housing member and having a gate body rim and a bottom plate with a second set of apertures, the bottom plate further including a center post that protrudes outwardly and is designed to contact the floor plate to facilitate rotational movement of the gate body within the bottom housing member, the gate body rim having at least one stopper tab protruding laterally from the gate body rim, wherein the floor plate and the first set of apertures of the bottom housing member are designed to facilitate powder mixing with the liquid and to provide filtering of non-dissolved powder. Also included is a top housing member designed to mate with the bottom housing member and encase the gate body, the top housing member having an upper opening threaded rim and a lower opening designed to rotatably engage with a lip arrangement on the bottom housing member rim, the top housing member further designed to rotate the gate body to align the second set of apertures of the gate body with the first set of apertures of the bottom housing member; and a removable cylindrical pliable cup body for holding the powder to be mixed, the pliable cup body designed to be located within the top and bottom housing and partially inside the gate body, the cup body having an outer ring on an exterior surface designed to be in contact with at least one release button protruding through the top member housing and in contact with the at least one stopper tab of the gate body, wherein the outer ring, the at least one stopper tab and the one release button member form a locking mechanism for the formula mixing assembly to prevent rotation of the top housing member and the gate body. In other related embodiments, the pliable cup body includes a set of measurement markings on an inner wall of the cup body adapted to provide dosing or mixing guidance and can be made from silicone or rubber materials or composites; and the bottom housing member mates with a rim of a circular sidewall of the mixing vessel via a friction fit arrangement. In another related embodiment, the at least one stopper tab of the locking mechanism includes an aperture designed to receive and engage a latching extension from the release button member, a portion of the release button member designed to be in contact with and receive an outward lateral force from the outer ring of the pliable cup body, the locking mechanism designed to be in a locked state until actuated or pressed inwardly by a user.

In yet another example embodiment, there is provided a powder mixing assembly designed to be coupled to an opening portion of a mixing vessel (such as a water or juice bottle used for fitness scenarios and athletic clubs) partially filled with a liquid (or can be filled at a later time for convenience), with the powder mixing assembly including a bottom housing member having a concave opening with a rim and a floor plate with a first set of apertures, the concave opening defined by an inner sidewall that mates with the floor plate, the bottom housing member including an outer sidewall adjacent the inner sidewall collectively defining a cavity therebetween adapted to receive a rim of the mixing vessel, wherein the floor plate and the first set of apertures of the bottom housing member are configured to facilitate powder mixing with the liquid and to provide filtering of non-dissolved powder. The mixing assembly further includes a top housing member configured to mate with the bottom housing member and having a cylindrical cup body portion therein configured to be disposed within the concave opening of the bottom housing member for holding the powder to be mixed, the cylindrical cup body portion having a bottom plate with a second set of apertures. Furthermore, the top housing member has an upper opening threaded rim and a lower opening threaded portion configured to radially rotatably engage with the bottom housing member rim, the top housing member further designed to radially rotate the cup body portion to align the second set of apertures of the cup body portion with the first set of apertures of the bottom housing member. In this example embodiment, the top and bottom housing members are held in vertical alignment as a single unit with a screw and nut assembly protruding through the floor and bottom plates of the top and bottom housing members. This example embodiment also includes at the bottom housing rim a rotation stopping assembly adapted to mate with a bottom surface of the top housing, wherein the radial rotation stopping assembly facilitates in the alignment of the first and second set of apertures to allow or prevent passage of powder from the cup body through to the mixing vessel. In this example embodiment, one or more outside tabs are optionally provided to enhance gripping and are not necessarily limited to engaging with a locking mechanism. Unlike the prior art, axial rotation and longitudinal movement to align the apertures is not required in this embodiment to promote flow through of powder and fluid.

Among other things, it is an advantage of the inventive concept to provide a baby or adult powder formula mixing device that does not suffer from any of the problems or deficiencies associated with prior solutions. It is still further an advantage of the inventive concept to have a powder mixing assembly that can be used with different powders and fluids.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIGS. 1A-1B illustrate a partial and full perspective views of a baby formula mixing and feed assembly according to the teachings herein.

FIGS. 2A-2B illustrate cutaway views of the formula mixing assembly without and with formula, respectively.

FIGS. 3A-3B illustrate upward and front exploded perspective views of the formula or powder mixing assembly, respectively.

FIGS. 4A-4C illustrate top and enlarged side views of the locking mechanism of the formula or powder mixing assembly.

FIGS. 5A-5B illustrate front and side internal views of the formula or powder mixing assembly with the various components including the locking mechanism.

FIG. 6 illustrates a perspective view of the formula or powder mixing assembly.

FIG. 7 illustrates the bottom view of the mixing assembly with a first set of apertures and a floor plate of a bottom housing member.

FIG. 8 illustrates the top view of the mixing assembly with a second set of apertures on a lower plate of a gate body with a center post at a center of the apertures.

FIGS. 9A and 9B illustrate front views of a second embodiment of a powder and formula mixing and feed assembly and powder mixing unit, respectively, according to the teachings herein.

FIGS. 10A-10D illustrate perspective, top, side and cutaway views of the assembled powder mixing unit to be used with a mixing vessel.

FIGS. 11A-11D illustrate perspective, top, side and cutaway views of a bottom housing of the powder mixing unit to be used with a mixing vessel.

FIGS. 12A-12D illustrate perspective, top, side and cutaway views of a top housing of the powder mixing unit to be used with a mixing vessel.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments described herein are directed to be a baby formula or food powder mixing assembly designed for use with standard baby feeding bottles or other bottles or containers such as sport bottles or adult protein mixing bottles.

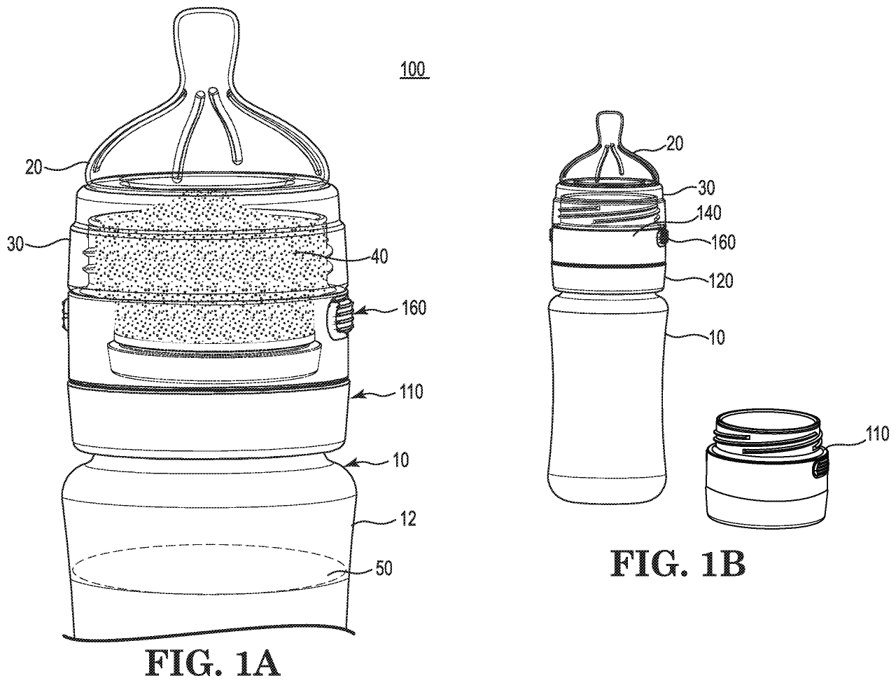

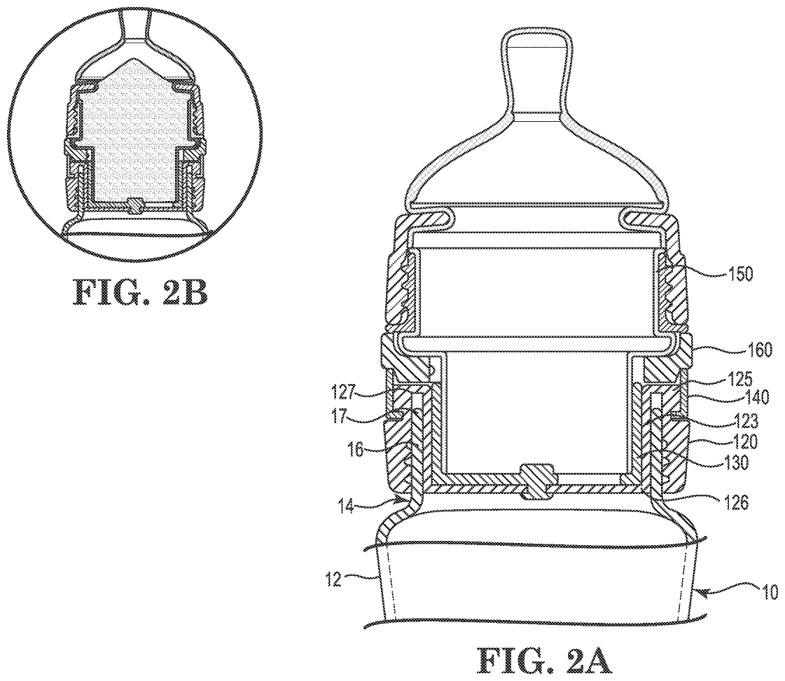

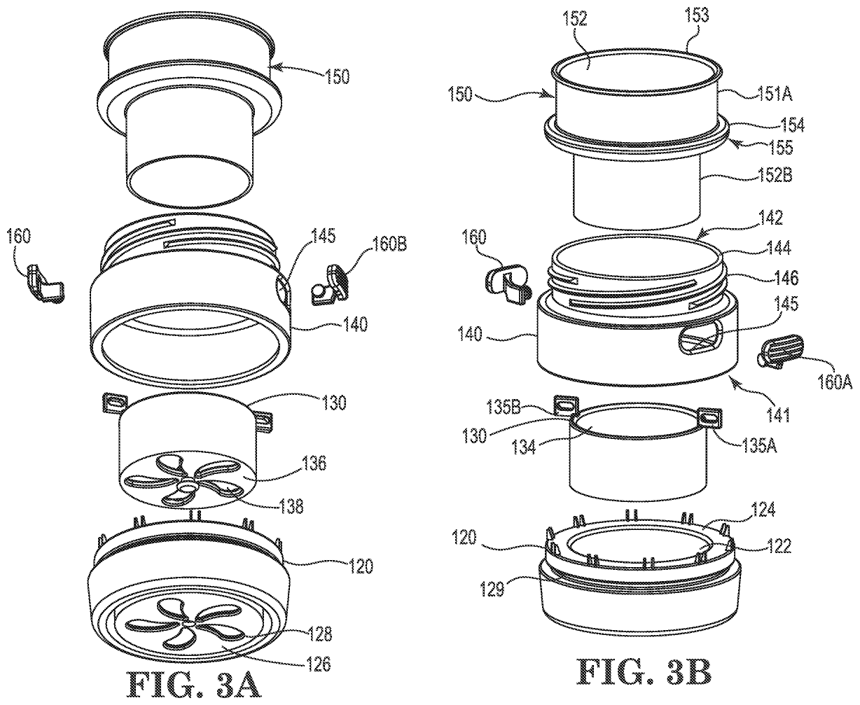

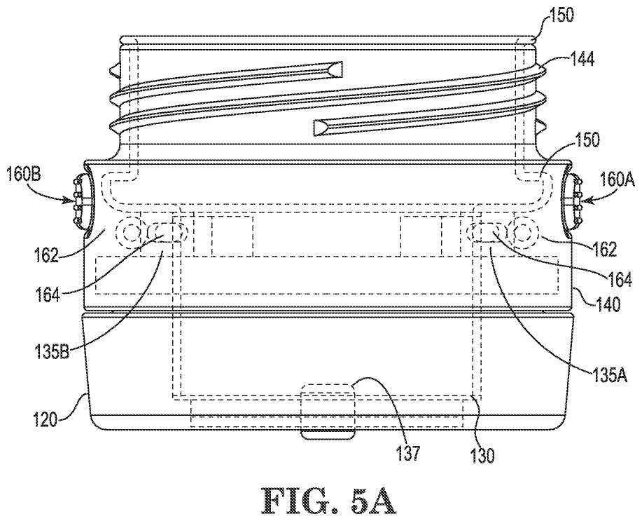

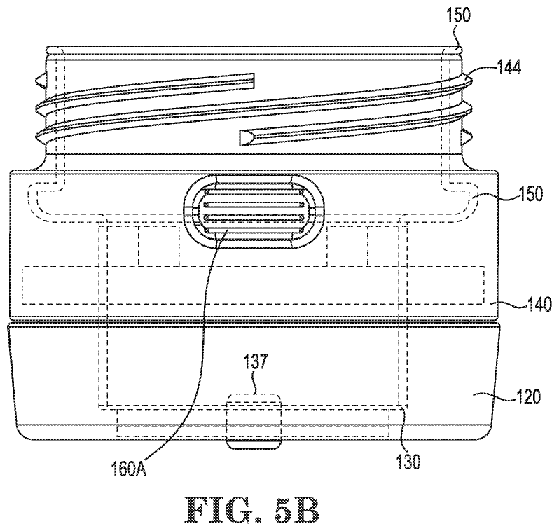

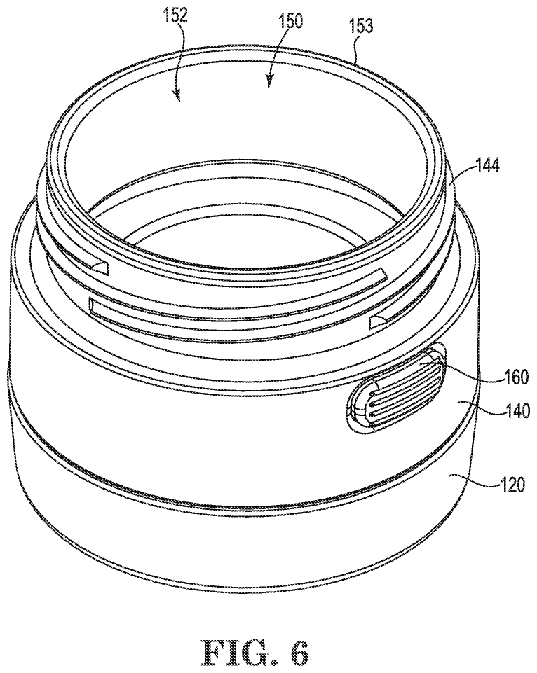

Referring now to the figures, FIGS. 1A-1B illustrate a partial and full perspective views of a baby formula mixing and feed assembly 100 according to the teachings herein. FIGS. 2A-2B illustrate cutaway views of the formula mixing assembly 110 without and with baby formula 40, respectively. In particular, a formula or powder mixing assembly 110 is designed to be placed over a baby bottle 10, but not necessarily limited to a baby bottle and can be other cylindrical vessels, that contains water 50. Bottle 10 includes a nipple 20 and a cap ring 30 that are attached to mixing assembly 110. In this example embodiment, and as will be discussed in more detail below, FIGS. 3A-3B illustrate upward and front exploded perspective views, respectively, of the various components of formula or powder mixing assembly 110. In this example embodiment, baby formula mixing assembly 110 includes at least four main components: a bottom housing member 120, a cylindrical gate body 130, a top housing member 140 and a cylindrical pliable cup body 150 which is disposed within the top/bottom housing 140/120. Further, FIGS. 5A-5B illustrate front and side internal views of the formula or powder mixing assembly 110 with the various components including the locking mechanism which restricts the top housing member and the gate body and silicone cup body from moving and releasing the formula into the bottle with the water or fluid. FIG. 6 also illustrates a perspective view of the assembled formula or powder mixing assembly 110.

Referring again to FIGS. 1A-3B in more detail, there is provided there is provided baby bottle formula mixing and feeding assembly 110 including a cylindrical vessel 10 having a body portion 12 with an opening portion 14, the opening portion 14 having a circular sidewall 16 protruding up from the body portion with a vessel rim 17. The baby bottle formula mixing and feeding assembly 110 also includes a standard nipple 20 and cap ring assembly 30 as well. In this example embodiment, the formula mixing assembly includes a bottom housing member 120 having a concave opening 122 with a bottom housing member rim 124 and a floor plate 126 with a first set of apertures 128, the concave opening 122 defined by an inner sidewall 123 that mates with the floor plate 126, the bottom housing member 120 including an outer sidewall 125 adjacent the inner sidewall 123 collectively defining a cavity 127 therebetween designed to receive the vessel rim 17. The cylindrical gate body 130 of mixing assembly 110 is designed to be disposed within the concave opening 122 of the bottom housing member 120 and have a gate body cavity 132 and a gate body rim 134 and a bottom plate 136 with a second set of apertures 138, the bottom plate 136 further including a center post 137 that protrudes outwardly and is designed to contact the floor plate 126 of bottom housing 120 to facilitate rotational movement of the gate body 130 within the bottom housing member 120. In this example embodiment, the apertures are teardrop in configuration to enhance mixing of powder with the fluid and to filter out clumps. Other aperture configurations include oval, round, slits or slots but are not limited to such shapes.

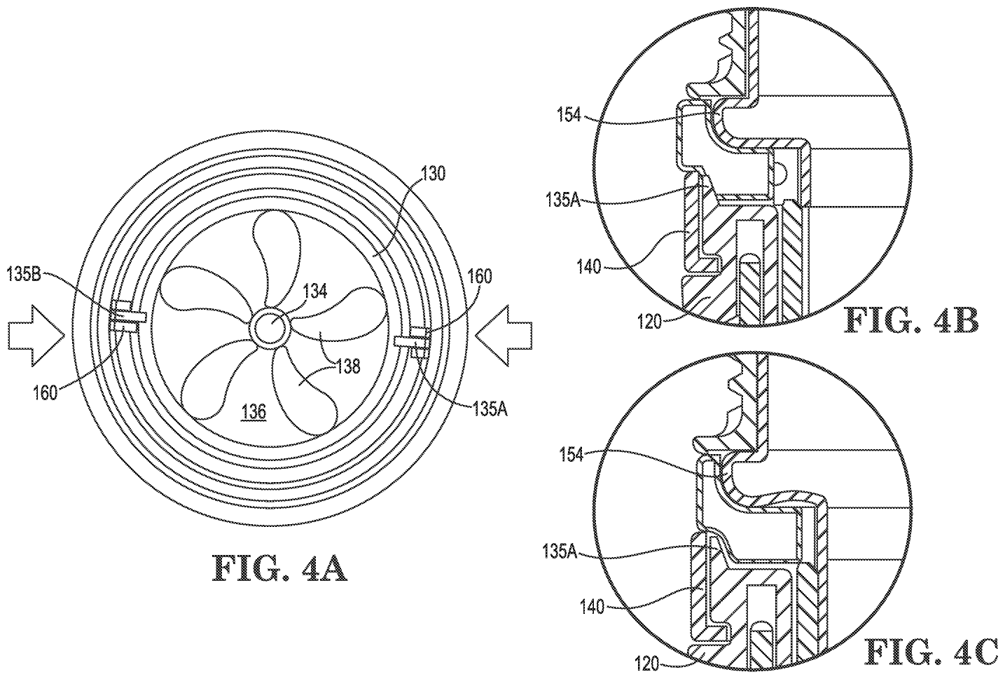

Referring now to FIGS. 4A-4C there is illustrated top and enlarged side views of the locking mechanism of the formula or powder mixing assembly 110. In this example embodiment, gate body rim 134 has at least one stopper tab 135A (two tabs 135A and 135B are shown) protruding laterally from the gate body rim 134 which prevent unintended rotation of the gate body and the bottom housing member 120 before intended by the user. The operation for unlocking the mechanism will be described further in the specification.

In this example embodiment, mixing assembly 110 includes top housing member 140 that is designed to mate with the bottom housing member 120 and encase the gate body 130. Top housing member 140 has a cavity 142 and an upper opening thread 146 and rim 144 and a lower opening 141 designed to rotatably engage with a lip arrangement 129 on the rim 124 of the bottom housing member 120. Top housing member 140 is further designed to rotate the gate body 130 to align the second set of apertures 138 of the gate body 130 with the first set of apertures 128 of the bottom housing member 120.

In this example embodiment, the mixing assembly 110 includes a cylindrical pliable cup body 150 (two part body 151A and 151B in this example) designed to be located within the top 140 and bottom 120 housing and partially inside the gate body 130, the cup body 150 having a cavity 152 for holding formula 40, a rim 153 and an outer ring 154 on an exterior surface 155 designed to be in contact with at least one release button 160A (two are shown, 160A and 160B) protruding through an aperture 145 in the top member housing 140. Outer ring 154 is in contact with the at least one stopper tab of the gate body (see FIG. 2A), such that the outer ring 154, the at least one stopper tab 135A and the one release button member 160A form a locking mechanism for the formula mixing assembly 110 to prevent rotation of the top housing member 140 and the gate body 130 during transport or handling. Finally, the nipple 20 and cap ring 30 assembly mates with the baby formula mixing assembly 110 with the cap ring 30 having a threaded surface 32 designed to be threaded onto the top housing member rim 144.

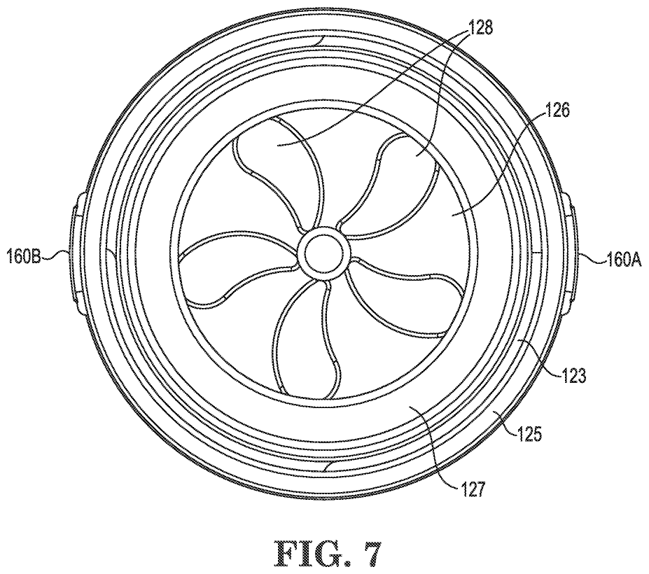

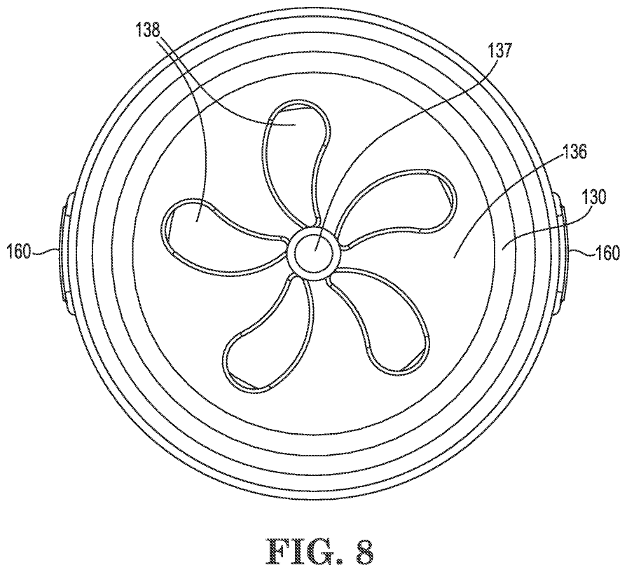

Referring now to FIGS. 7 and 8, respectively, there is illustrated a bottom view of the mixing assembly 110 with a first set of apertures 128 and a floor plate 126 of a bottom housing member 120 and the top view of the mixing assembly 110 with a second set of apertures 138 on a lower plate 136 of a gate body 130 with a center post 137 at a center of the apertures. As discussed earlier, the unlocking of the top housing from the bottom housing permits the rotation of the top housing member 140 with the cup body 130 and the silicone body 150 so as to align both sets of apertures 128 and 138 and release the formula or powder into the mixing baby bottle or athletic bottle. Floor 126 and apertures 128 of bottom housing 120 not only promotes effective mixing but also assist in filter undissolved formula or powder that may go into the upper portion of silicone cup 150 or the top housing 140 and into the nipple/cap assembly, thereby potentially clogging the nipple hole or bottle cover.

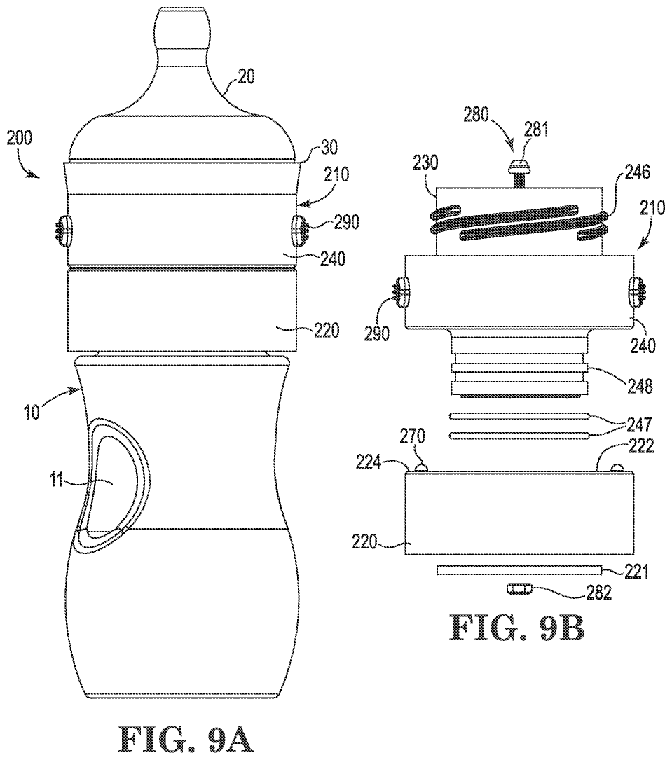

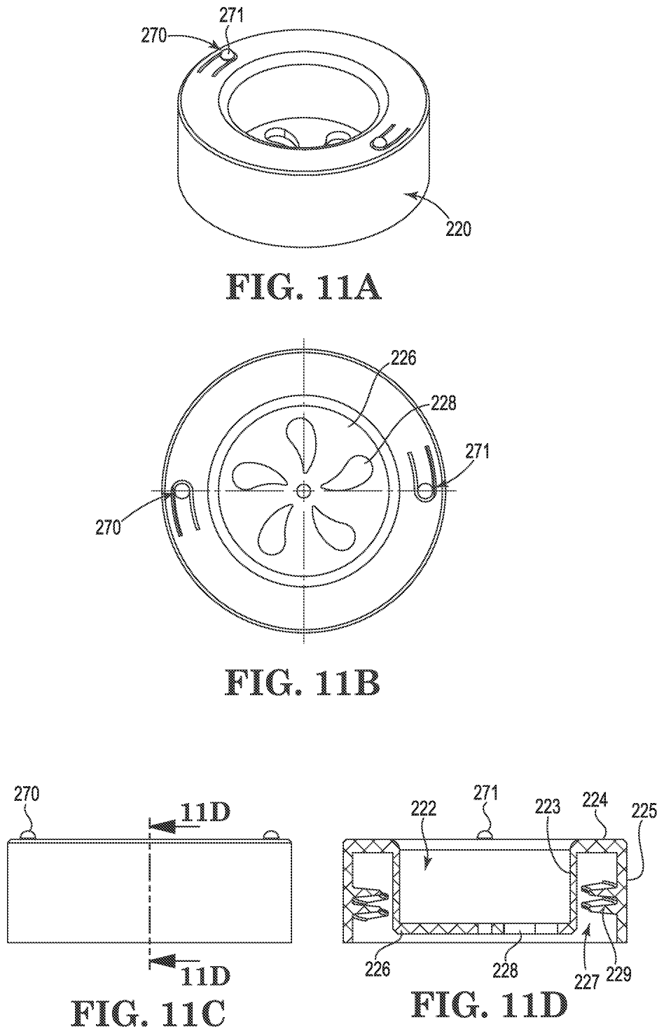

Referring now to a second embodiment of a formula or powder mixing assembly 200 and powder mixing unit 210, reference is now made to FIGS. 9-12, which illustrate various aspects of assembly 200 and mixing unit 210. Referring now to FIGS. 9A and 9B and FIGS. 11A-11B, a powder mixing assembly 200 is provided and designed to be coupled to an opening portion of a mixing vessel 10 (such as a water or juice bottle used for fitness scenarios and athletic clubs) partially filled with a liquid 50 (or can be filled at a later time for convenience), with the powder mixing unit 210. In this example embodiment, vessel 10 includes an indent 11 for ease of gripping by a user. Mixing unit 210 includes a bottom housing member 220 having a concave opening 222 with a rim 224 and a floor plate 226 with a first set of apertures 228, the concave opening 222 defined by an inner sidewall 223 that mates with the floor plate 228, the bottom housing member including an outer sidewall 225 adjacent the inner sidewall 223 collectively defining a cavity 227 and thread 229 (for threading onto the opening of vessel 10) therebetween designed to receive a rim of the mixing vessel 10, wherein the floor plate 226 and the first set of apertures 228 of the bottom housing member 220 are configured to facilitate powder mixing with the liquid and to provide filtering of non-dissolved powder. In this example embodiment, a sealing ring 221 is optionally included to improve the seal between mixing unit 210 and vessel 10. A stopping mechanism 270, in the form of a pin or post 271, which will be described in more detail later, to help with operation of mixing unit 210 in deploying the mixing powder into the mixing vessel 10.

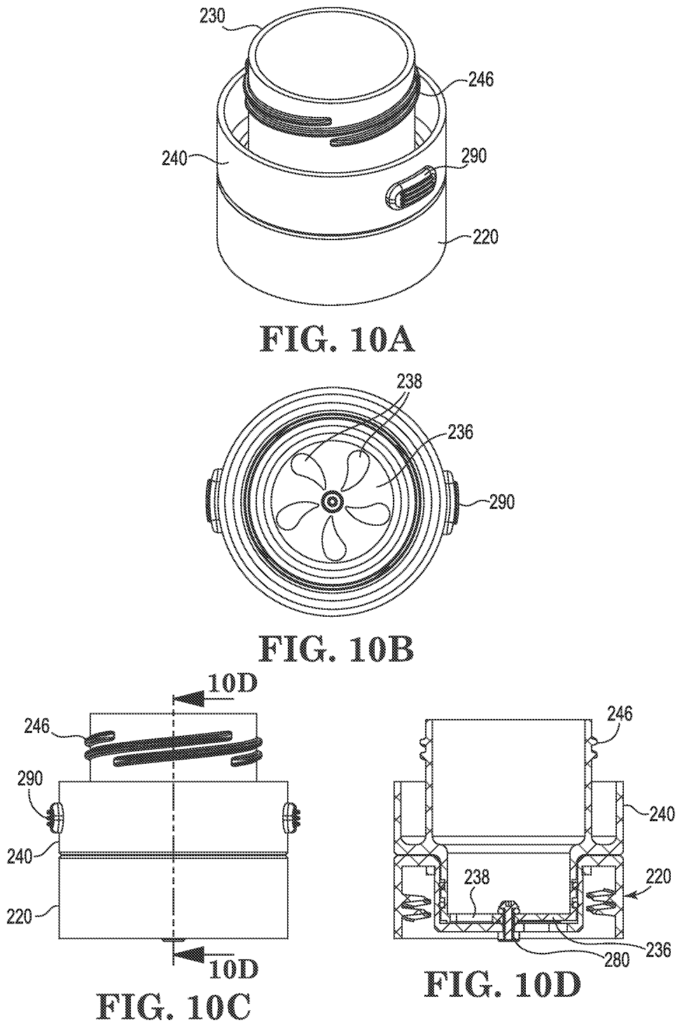

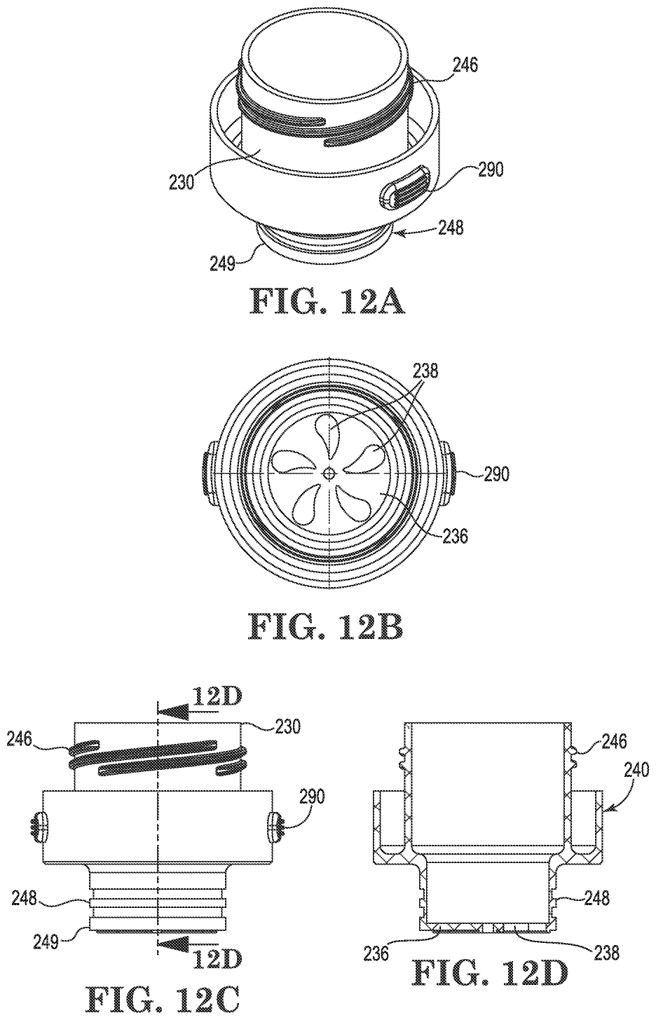

In this example embodiment and referring now to FIGS. 10A-10D and 12A-12D, mixing assembly unit 210 further includes a top housing member 240 configured to mate with the bottom housing member 220 and having a cylindrical cup body portion 230 therein configured to be disposed within the concave opening 222 of the bottom housing member 220 for holding the powder to be mixed, while the top housing member 240 has an upper opening threaded rim 246 for engaging a cover of vessel 10 or engaging a cap/nipple arrangement for a baby bottle. Cylindrical cup body portion 230 has a bottom plate 236 with a second set of apertures 238 and a lower opening threaded portion 248 configured to radially rotatably engage with the bottom housing member opening 222 and rim 224. Optionally and for improved sealing, unit 210 includes one or two O-rings 247 interposed between rim 249 and housing 220. In this example embodiment, top housing member 240 is further designed to rotate the cup body portion 230 to align the second set of apertures 238 of the cup body portion 230 with the first set of apertures 228 of the bottom housing member 220.

Referring again to FIGS. 10B and 10D, in this example embodiment, the top and bottom housing members 220 and 240, respectively, are held in vertical alignment as a single unit with a screw 282 and nut 284 as a fastening assembly 280 protruding through the floor and bottom plates 226 and 236, respectively, of the top and bottom housing members. This example embodiment also includes at the bottom housing rim 249 a rotation stopping assembly 270 designed to mate with a bottom surface 249 of the top housing 240, wherein the radial rotation stopping assembly 270 facilitates in the alignment of the first and second set of apertures 228 and 238 to allow (both sets of apertures aligned) or prevent (both sets not aligned) passage of powder from the cup body 230 through to the mixing vessel 10. In this example embodiment, mixing unit 210 includes grip members 290 to assist in radially rotating cup body 230 about bottom housing 220. Apertures 228 and 238 also help in filter out clumps or breaking them up with shaking the entire bottle and cap assembly 200.

In related embodiments, mixing assembly can be modified to accommodate K-cup style cartridges with pre-filled formula or can be filed each time and inserted when needed. In another embodiment, a bioresorbable or gel-filled formula capsule that can be dropped into the water-filled bottle and shaken before feeding.

The following patents are incorporated by reference in their entireties: U.S. Pat. Nos. 7,850,027; 8,556,094 and 9,629,782.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A formula and powder mixing and feeding assembly comprising:
a cylindrical vessel having a body portion with an opening portion, the opening portion having a circular sidewall protruding up from the body portion with a vessel rim;
a formula mixing assembly adapted to be coupled with the opening portion of the cylindrical vessel, the formula mixing assembly including:
a bottom housing member having a concave opening with a bottom housing member rim and a floor plate with a first set of apertures, the concave opening defined by an inner sidewall that mates with the floor plate, the bottom housing member including an outer sidewall adjacent the inner sidewall collectively defining a cavity therebetween adapted to receive the vessel rim;
a cylindrical gate body adapted to be disposed within the concave opening of the bottom housing member and having a gate body rim and a bottom plate with a second set of apertures, the bottom plate further including a center post that protrudes outwardly and is adapted to contact the floor plate to facilitate radial rotational movement of the gate body within the bottom housing member, the gate body rim having at least one stopper tab protruding laterally from the gate body rim;
a top housing member adapted to mate with the bottom housing member and encase the gate body, the top housing member having an upper opening threaded rim and a lower opening adapted to rotatably engage with a lip arrangement on the rim of the bottom housing member, the top housing member further adapted to radially rotate the gate body to align the second set of apertures of the gate body with the first set of apertures of the bottom housing member to facilitate flow through; and
a cylindrical pliable cup body adapted to be located within the top and bottom housing and partially inside the gate body, the cup body having an outer ring on an exterior surface adapted to be in contact with at least one release button protruding through the top member housing and in contact with the at least one stopper tab of the gate body, wherein the outer ring, the at least one stopper tab and the one release button member form a locking mechanism for the formula mixing assembly to prevent radial rotation of the top housing member and the gate body; and
a nipple and cap ring assembly adapted to mate with the baby formula mixing assembly, the cap ring having a threaded surface adapted to be threaded onto the top housing rim.

2. The baby bottle feeding assembly of claim 1 wherein the at least one stopper tab of the locking mechanism includes an aperture adapted to receive and engage a latching extension from the release button member, a portion of the release button member adapted to be in contact with and receive an outward lateral force from the outer ring of the pliable cup body, the locking mechanism adapted to be in a locked state until actuated.

3. The baby bottle feeding assembly of claim 1 wherein the pliable cup body is made of a material selected from the group of silicone and rubber.

4. The baby bottle feeding assembly of claim 1 wherein the vessel rim includes a male thread on an outer surface of the circular sidewall.

5. The baby bottle feeding assembly of claim 4 wherein the outer sidewall of the bottom housing member includes a female thread adapted to receive the vessel rim male thread.

6. The baby bottle feeding assembly of claim 1 wherein the baby formula mixing assembly and the vessel rim of the circular sidewall mate at the bottom housing member via a friction fit arrangement.

7. The baby bottle feeding assembly of claim 2 wherein the locking mechanism includes at least two stopper tabs and two release button members disposed in diametrically opposed locations on the baby formula mixing assembly.

8. The baby bottle feeding assembly of claim 1 wherein the pliable cup body includes a set of measurement markings on an inner wall of the cup body adapted to provide dosing or mixing guidance.

9. The baby bottle feeding assembly of claim 1 wherein a shape of the first and second set of apertures is selected from the group consisting of round, oval, slits and oblong.

10. The baby bottle feeding assembly of claim 1 wherein the floor plate and the first set of apertures of the bottom housing member are adapted to promote formula mixing and to provide filtering of non-dissolved formula from reaching the nipple and facilitate lump breakup.

11. A baby formula mixing assembly adapted to be coupled with an opening portion of a mixing vessel, the formula mixing assembly comprising:
a bottom housing member having a concave opening with a bottom housing member rim and a floor plate with a first set of apertures, the concave opening defined by an inner sidewall that mates with the floor plate, the bottom housing member including an outer sidewall adjacent the inner sidewall collectively defining a cavity therebetween adapted to receive a rim of the mixing vessel;
a cylindrical gate body adapted to be disposed within the concave opening of the bottom housing member and having a gate body rim and a bottom plate with a second set of apertures, the bottom plate further including a center post that protrudes outwardly and is adapted to contact the floor plate to facilitate radial rotational movement of the gate body within the bottom housing member, the gate body rim having at least one stopper tab protruding laterally from the gate body rim;
a top housing member adapted to mate with the bottom housing member and encase the gate body, the top housing member having an upper opening threaded rim and a lower opening adapted to radially rotatably engage with a lip arrangement on the bottom housing member rim, the top housing member further adapted to radially rotate the gate body to align the second set of apertures of the gate body with the first set of apertures of the bottom housing member; and
a cylindrical pliable cup body adapted to be located within the top and bottom housing and partially inside the gate body, the cup body having an outer ring on an exterior surface adapted to be in contact with at least one release button protruding through the top member housing and in contact with the at least one stopper tab of the gate body, wherein the outer ring, the at least one stopper tab and the one release button member form a locking mechanism for the formula mixing assembly to prevent rotation of the top housing member and the gate body.

12. The baby formula mixing assembly of claim 11 wherein the at least one stopper tab of the locking mechanism includes an aperture adapted to receive and engage a latching extension from the release button member, a portion of the release button member adapted to be in contact with and receive an outward lateral force from the outer ring of the pliable cup body, the locking mechanism adapted to be in a locked state until actuated.

13. The baby formula mixing assembly of claim 11 wherein the floor plate and the first set of apertures of the bottom housing member are adapted to promote formula mixing and to provide filtering of non-dissolved formula before reaching an upper portion of the pliable cup body.

14. The baby formula mixing assembly of claim 11 wherein the pliable cup body includes a set of measurement markings on an inner wall of the cup body adapted to provide dosing or mixing guidance.

15. The baby formula mixing assembly of claim 11 wherein the pliable cup body is made of a material selected from the group of silicone and rubber.

16. The baby formula mixing assembly of claim 1 wherein a shape of the first and second set of apertures is selected from the group consisting of round, oval, slits and oblong.

17. A formula and powder mixing assembly adapted to be coupled to an opening portion of a mixing vessel partially filled with a liquid, the powder mixing assembly comprising:
a bottom housing member having a concave opening with a rim and a floor plate with a first set of apertures, the concave opening defined by an inner sidewall that mates with the floor plate, the bottom housing member including an outer sidewall adjacent the inner sidewall collectively defining a cavity therebetween adapted to receive a rim of the mixing vessel, wherein the floor plate and the first set of apertures of the bottom housing member are adapted to facilitate powder mixing with the liquid and to provide filtering of non-dissolved powder; and
a top housing member adapted to mate with the bottom housing member and having a cylindrical cup body portion therein adapted to be disposed within the concave opening of the bottom housing member for holding the powder to be mixed, the cylindrical cup body portion having a bottom plate with a second set of apertures, the top housing member having an upper opening threaded rim and a lower opening threaded portion adapted to radially rotatably engage with the bottom housing member rim, the top housing member further adapted to radially rotate the cup body portion to align the second set of apertures of the cup body portion with the first set of apertures of the bottom housing member, wherein the aligned first and second apertures facilitate mixing of contents within the mixing vessel and assist in filtering out undissolved powder in the mixing vessel.

18. The powder mixing assembly of claim 17 wherein the cup body portion includes a set of measurement markings on an inner wall of the cup body adapted to provide dosing or mixing guidance.

19. The powder mixing assembly of claim 17 wherein the top and bottom housing members are held in vertical alignment as a single unit with a screw and nut assembly protruding through the floor and bottom plates of the top and bottom housing members.

20. The powder mixing assembly of claim 17 wherein the bottom housing rim includes a radial rotation stopping assembly adapted to mate with a bottom surface of the top housing, wherein the radial rotation stopping assembly facilitates in the alignment of the first and second set of apertures to allow or prevent passage of powder from the cup body through to the mixing vessel.
